(19) United States
(12) Patent Application Publication
(10) Pub. No.: US 2023/0183899 A1
(43) Pub. Date: Jun. 15, 2023

(54) COMPUTER ASSISTED TUFTING

(71) Applicant: PONGRASS, Robert Gabor, Bondi Junction (AU)

(72) Inventor: Robert Gabor Pongrass, Bondi Junction (AU)

(21) Appl. No.: 17/999,810

(22) PCT Filed: May 26, 2021
(86) PCT No.: PCT/AU2021/050498

§ 371 Date: Nov. 23, 2022

(30) Foreign Application Priority Data
May 28, 2020 (AU) 2020901752

(51) Int. Cl. D05C 15/30; D05C 15/14; D05C 15/20; G05B 19/4155

(52) U.S. Cl. CPC D05C 15/30; D05C 15/14; D05C 15/20; G05B 19/4155; G05B 2219/45192; G05B 2219/50391

(57) ABSTRACT

A computer implemented method (100) and system (200) for indexed tufting of a backing material (200) by a robot tufter. The method comprises: receiving (102) or accessing grid geometry of a backing material (200) wherein the grid geometry is based on a periodicity and dimensions of grid locations (204) of the backing material (200) and representative of optimal locations to receive a tufting needle; determining (104) indexed positions of grid locations of the backing material relative to the tufting needle of the robot tufter using a reference point that is fixed relative to the backing material (200); and controlling (106) the robot tufter to penetrate one or more specified indexed grid locations of the backing material with the tufting needle to create a tuft at the one or more specified indexed grid locations.

### TECHNICAL FIELD

The disclosure relates to robot tufters and methods for controlling robot tufters.

### BACKGROUND

Wall-to-wall carpet is derived from the concept of fitted carpet, as produced in France from the 17th century. Starting with a design satisfying the patron's requirements and an overall shape to match a room, individual pieces of fabric were woven as tapestries, joined together as a mosaic and attached to the floor to provide complete coverage of the floor area. The individual pieces of fabric were each manually woven by workers to predetermined shapes and sizes such that there was no material wastage with the carpet design matched to the room shape and size. In current terminology a ‘fitted carpet’ was an example of a product that integrated a consumer centric, design driven approach with additive or zero waste manufacturing.

In modern times, carpets are usually produced using broadloom weaving or tufting to mass produce rolls of carpets of standardised widths for high production volume. Sections are cut from the rolls and laid side-by-side to provide complete coverage of the floor area. This is achievable regardless of the shape of the floor and is termed wall-to-wall carpet.

### SUMMARY

According to a first aspect, there is provided a computer implemented method for indexed tufting of a backing material by a robot tufter, the method comprising:

receiving or accessing grid geometry of a backing material wherein the grid geometry is based on a periodicity and dimensions of grid locations of the backing material and representative of optimal locations to receive a tufting needle;
determining indexed positions of grid locations of the backing material relative to the tufting needle of the robot tufter using a reference point that is fixed relative to the backing material; and
controlling the robot tufter to penetrate one or more specified indexed grid locations of the backing material with the tufting needle to create a tuft at the one or more specified indexed grid locations.

The one or more specified indexed grid locations may comprise boundary locations and wherein the boundary locations are determined by:

identifying a motif boundary of a motif in a design for a tufted article wherein the design comprises a configuration of one or more motifs of the tufted article, a shape of the article and dimensions of the article; and
discretising the motif boundary using the grid geometry to determine the boundary locations.

The motif boundary may be discretised to grid locations that are separated by a minimum distance.

The one or more specified indexed locations may further comprises fill locations, wherein the fill locations are discretised to grid locations between boundary locations.

The fill locations may be separated by an integral number of grid locations.

The integral number of grid locations may be determined by a tuft density specified in the design for the tufted article.

Controlling the robot tufter may include tufting the backing material in accordance with a design.

The design may comprise textile construction parameters.

The textile construction parameters may comprise a tufting texture.

The textile construction parameters may comprise a tufting density.

The design may comprise a loading map and the tufting density is determined by the loading map.

The design may comprise a curvature of the article surface and the tufting density is determined by the curvature.

The design may comprise an acoustic map and the textile construction parameters are determined by the acoustic map.

Determining the indexed position of grid locations may comprise segmenting the design based on the dimensions.

The design may be specified by a computer assisted design (CAD) file and the step of determining indexed positions of grid locations comprises generating a computer aided manufacturing (CAM) file based on the CAD file and the grid geometry of the backing material.

The CAM file may comprise a list of vector movements to control the robot tufter.

According to a second aspect, there is provided a system for indexed tufting of a backing material, the system comprising:
a robot tufter comprising:
   a tufting frame for holding a backing material to be tufted;
   a tufting head having a tufting needle to create one or more tufts in the backing material; and
a controller to control the robot tufter, the controller configured to:
   receive or access grid geometry of the backing material wherein the grid geometry is based on a periodicity and dimensions of grid locations of the backing material and representative of optimal locations to receive the tufting needle;
   determine indexed positions of grid locations of the backing material relative to the tufting needle of the robot tufter using a reference point that is fixed relative to the backing material; and
   control the robot tufter to penetrate one or more specified indexed grid locations of the backing material with the tufting needle to create a tuft at the one or more specified indexed grid locations.

According to a third aspect, there is provided a tufted article produced using the methods described above.

According to a fourth aspect, there is provided a non-transitory computer readable medium configured to store software instructions that when executed cause a processor to perform the methods described above.

According to a fifth aspect there is provided a non-transitory computer readable medium configured to store software instructions that when executed cause a processor to:

receive or access grid geometry of the backing material wherein the grid geometry is based on a periodicity and dimensions of grid locations of the backing material and representative of optimal locations to receive the tufting needle;
determine indexed positions of grid locations of the backing material relative to the tufting needle of the robot tufter using a reference point that is fixed relative to the backing material; and
control the robot tufter to penetrate one or more specified indexed grid locations of the backing material with the tufting needle to create a tuft at the one or more specified indexed grid locations.

### BRIEF DESCRIPTION OF DRAWINGS

FIG. 1 illustrates a method for indexed tufting;

FIG. 2 is an illustration of a backing material;

FIG. 3 is an illustration of a 3 dimensional design for a carpet;

FIG. 4A to FIG. 4E illustrate the effects of curvature on unmodified carpet tufts;

FIG. 4F and FIG. 4G illustrate modified carpet tufts for exemplary curvatures.

FIG. 5A illustrates a floor plan for which a carpet is to cover;

FIG. 5B illustrates a motif for the carpet;

FIG. 5C illustrates a load map for the carpet;

FIG. 6 illustrates a method discretisation;

FIG. 7 illustrates a system for indexed tufting; and

FIG. 8 illustrates a controller for the system of FIG. 7.

### DESCRIPTION OF EMBODIMENTS

As mentioned, with the advent of broadloom weaving carpet manufacture, ‘fitted carpet’ became ‘wall-to-wall carpet’ with carpet pieces cut from rolls of mass produced carpet material. Manufacturers determine which carpet designs they produce thereby limiting consumer choice and making wall-to-wall carpet a manufacturing centred product. The actual carpet design for wall-to-wall carpet is independent of the shape and size of the room in which it is installed. The shape and size of the carpet is determined by a carpet layer who measures the room to be carpeted and determines how many rolls of material are required. Cutting and fitting wall-to-wall carpet is a tailoring process which results in material waste of the original broadloom source material: this material waste is referred to as carpet offcuts. The rate of carpet wastage, depending on the carpet design and texturing effects, varies from 10% up to 30%, with plain unpatterned carpet having the least offcut wastage: installation of wall-to-wall carpet can be considered as “cut-and-waste”. The installation of wall-to-wall carpet is a multi-stage manufacturer centric subtractive manufacturing process, generating carpet waste in the form of carpet offcuts. Carpet manufacturers are disconnected from the consumer's ultimate use of its product and have no responsibility for the waste generated.

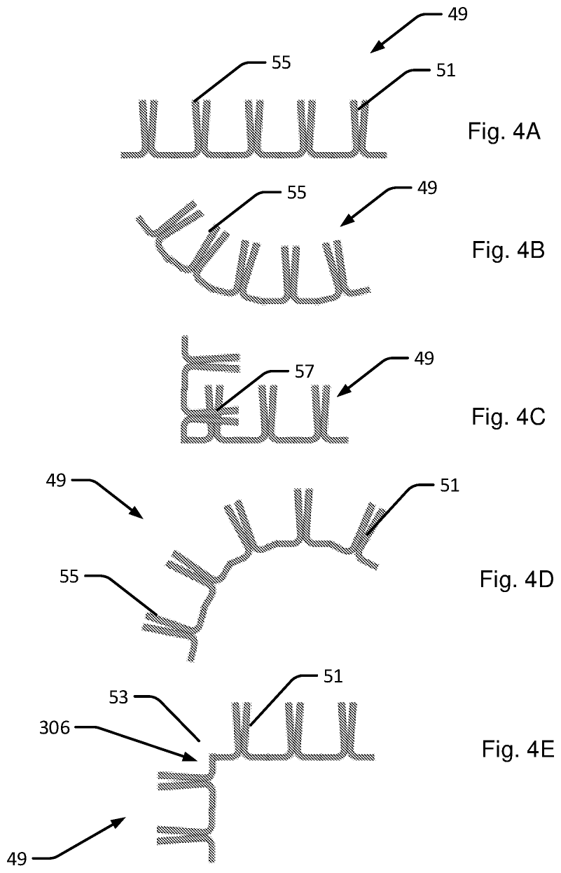

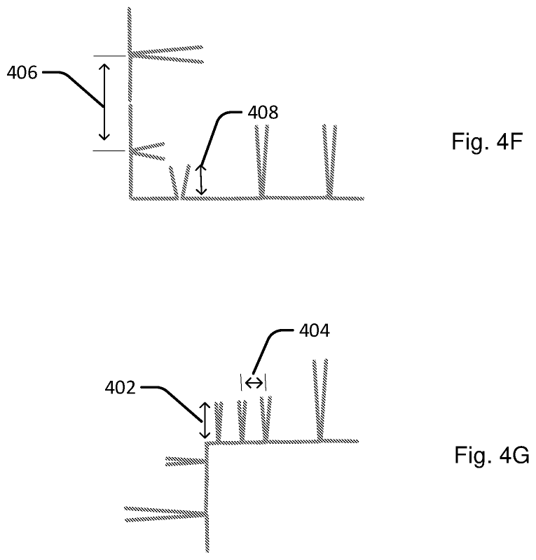

One issue includes the way curvatures in carpet affects the density of tufts as illustrated in FIGS. 4A to 4E. FIG. 4A illustrates carpet 49 that is substantially flat with substantially even distribution of tufts 55 in the pile 51. FIG. 4B illustrates the carpet 49 following a concave curvature that increases the density of tufts 55. In other words, the individual tufts are closer to one another. FIG. 4C illustrates the carpet 49 following a corner 308 (at a right angle), whereby some tufts 57 at the corner 308 overlap one another to provide a very high density of tufts. Typically, the area at the corner 308 is low wear and therefore a high density is not necessary. FIG. 4D illustrates the carpet 49 following a convex curvature where the tufts 55 of the pile 51 are spread out form one another that reduces the tuft density. FIG. 4E illustrates carpet 49 at a nose 306 of a stair case that includes an opening 53 in the pile 51.

Since the 1950's tufting replaced weaving as the dominant method of carpet manufacture, with around 90% of all mass produced broadloom carpet material produced on multi-needle tufting machines. Wall-to-wall carpet installation, using broadloom carpet material, occupies over 60% of the total carpet market and as such is a major source of carpet waste. As tufting has displaced weaving as the dominant carpet manufacturing technology it has also diminished the overall utility of carpet. Whereas woven carpet enabled production of complex designs and large pattern repeats with multiple colours, up to 20 with Axminster weaving, multi-needle tufting has limited design capabilities and generally utilises less than 4 colours. This reduced design capability has led to a diminution of the artistic functionality of wall-to-wall carpet. Further to this, high set-up costs of broadloom tufting determine the minimum economic batch size for a mass production of a design which effectively reduces the variety of designs available to consumers.

Currently robot tufting machines fill tufted areas using computer algorithms to create stitch vectors that utilise variable stitch length and variable angle that are not orthogonally constrained. These stitch vectors are used for outlining and filling shapes within a design and for outlining shapes resulting in smooth curves around a design to eliminate jagged edges. This method of robot tufting has a number of disadvantages:
stitches and tufting needle penetrations are not related to the geometry of the backing material grid to be tufted
needle penetrations are independent of backing grid spaces with poor placement causing distortion of possible damage to the backing material
stitch length and stitch spacing are not constrained by nominal values with variations causing irregular stitch patterns
filling shapes with non-orthogonal stitch lines distorts the backing material and changes the geometry of a design
patterns are laborious and inconvenient to edit

### Computer Integrated Manufacturing

As discussed above, producing custom carpets could be beneficial for, among other things, reducing carpet waste. However, currently the design and manufacture of a custom designed takes a minimum of several weeks and usually several months. It involves a number of separate and discrete steps with each step carried out by a different person, usually in different physical locations. Records for each part of the process may be stored in different forms, electronic or paper, with little or no integration of the information. In the event of an error in the carpet design there is no audit trail to identify the source of the error. Custom carpets are expensive and have long delivery times.

A method of eliminating carpet offcuts is to revert to the consumer centric additive manufacturing process of making wall-to-wall carpet as a mosaic of carpet materials pieces each designed to contribute to the fitted carpet without material waste. This method of fitted carpet manufacture has been carried out using traditional hand tufting for custom designed wall-to-wall carpet. Since the 1980's hand tufting has been automated using tufting robots as pioneered by Wilcom, using computer CAD/CAM systems for design and manufacturing. In a carpet market dominated by the tufting process with drawbacks discussed above, it is desirable to use robot tufting as the means of producing custom designed carpet pieces for the zero waste manufacturing of wall-to-wall carpet. This additive manufacturing process can be considered as “tuft-to-fit” with the use of computers enabling carpet design to be matched to the room shape and size in a one stage design/manufacture/install process—computer integrated carpet manufacture CICM.

Furthermore, existing methods of robot tufting machine control generate needle penetrations independently of, and without reference to, grid locations in a backing material to be tufted. Needle penetration points are determined and adjusted relative to tufts in a design and not in relation to the backing grid itself. Irregular needle penetrations may distort both backing material and design. The tip of the needle may hit the backing material filaments leading to filament breakage which creates holes in the backing material. It is desirable to have a system that allows custom designs that takes into account the backing material such that the needle penetrations do not damage or undesirably distort the backing material.

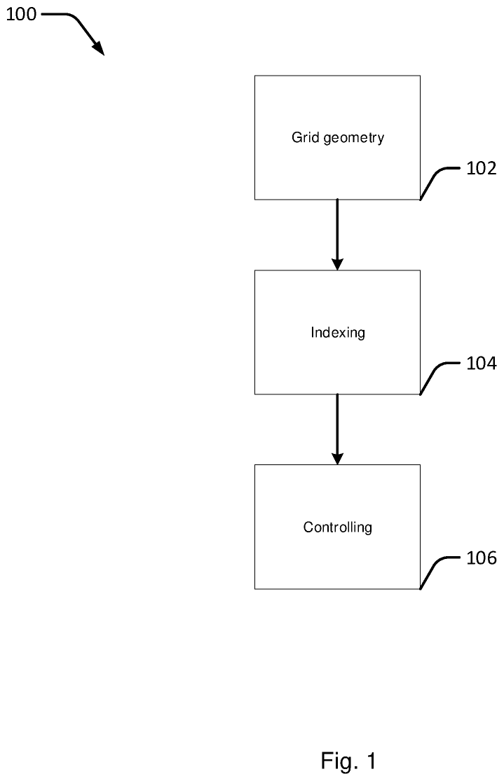

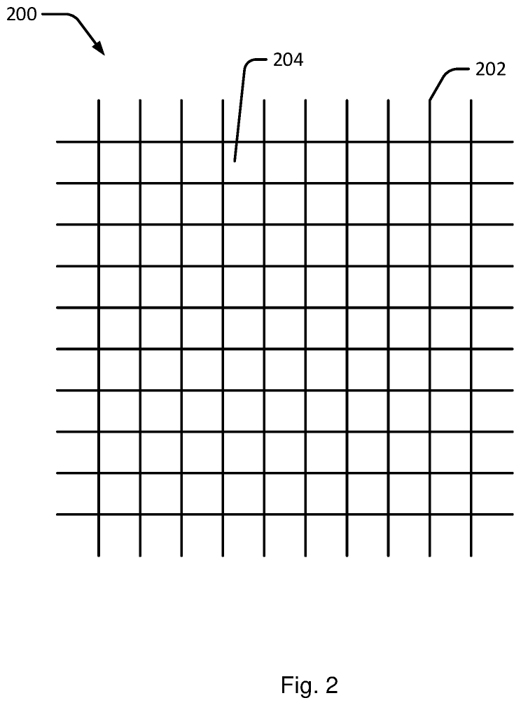

FIG. 1 illustrates a method 100 for producing a custom carpet using a robot tufter. The robot tufter produces tufts in a woven backing material 200 as illustrated in FIG. 2 using a tufting needle. Backing material 200 comprises filaments 202 woven into an orthogonal grid pattern with grid locations 204 between filaments 202. Grid locations 204 are the optimal locations to receive a tufting needle which is used to form a tuft at the grid location. Backing material 200 is retained on a tufting frame such as that described in Australian provisional patent application number: 2020900821. The robot tufter may comprise a tufting gun, including a tufting needle, such as that described in Australian provisional patent applications: 2019904414 and 2020900821 (these applications are filed by the present applicant and the contents therein are incorporated by reference in this application).

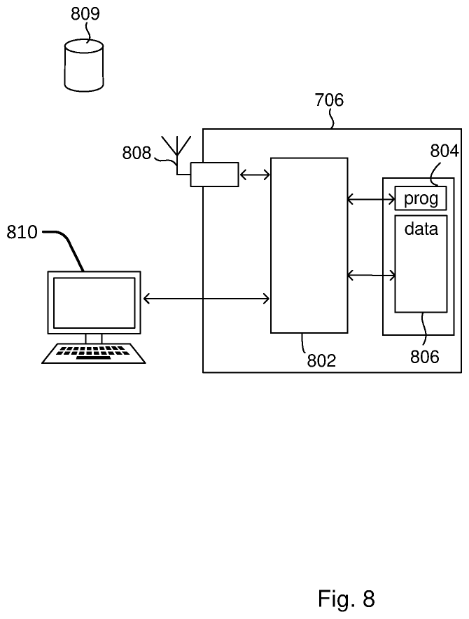

Method 100 is performed by a computer, or controller, which controls a robot tufter. At step 102 of method 100, a grid geometry of backing material 200 is received by the computer which is represented by controller 706 in FIG. 8. The grid geometry is based on a periodicity and dimensions of grid locations 204 of backing material 200.

In some embodiments, the grid geometry is provided by a user through an interface 810 as shown in FIG. 8. In some embodiments, the grid geometry is accessed from a data store, which may be local such as data repository 806, or external, such as backing material data repository 809. In some embodiments, the grid geometry is determined using a light source to illuminate backing material 200 and an optical detector to receive illumination light which is backscattered or transmitted though backing material 200. A signal generated by the optical detector can be used to determine the grid geometry by processor 802 of controller 706 or some other processor. The illumination source and optical detector can be located in any suitable spot such as on the tufting frame or tufting head. In some examples, the optical detector is a digital camera that captures video and/or still images of the backing material.

At step 104 of method 100, the controller determines indexed positions of grid locations 204 of the backing material relative to the tufting needle of the robot tufter. The indexed positions are determined using a reference point that is fixed relative to the backing material and the grid geometry. For example, the reference point may be a predetermined point on the tufting frame or backing material such as a grid location. The controller then determines the locations of all grid locations from the reference point using the grid geometry.

The controller then controls (106) the robot tufter to penetrate one or more specified indexed grid locations of the backing material with the tufting needle to create a tuft at the one or more specified indexed grid locations. Method 100 ensures that every needle penetration takes place in a specified backing grid space. It identifies the location of every grid space of the backing material grid network within the tufting frame. The method controls the point of needle penetration, linking it to a specified grid space. This method is deterministic and eliminates the possibility of the needle hitting the backing filaments, which action may distort the backing material.

Method 100 may comprise controlling the robot tufter to tuft backing material 200 in accordance with a design. The design may be specified in a computer aided design (CAD) file and may comprise a configuration of one or more motifs, discussed in more detail below, a shape of the article and dimensions of the article. In this case, the specified indexed grid locations are determined by discretising the design using the grid geometry.

In some embodiments, this involves down sampling the design to a lower ‘pixelated’ resolution based on the grid geometry. The down sampled design can have a maximum resolution being equal to the grid spacings of the backing material and a minimum resolution being equal to the minimum required tufting density. These are described in more detail below.

Apart from visual aspects, the design may further comprise textile construction parameters. The textile construction parameters may comprise one or more of tuft type (open pile or loop), tuft length, and tufting density. It will be appreciated that such a design will allow the textile construction parameters to vary across the carpet.

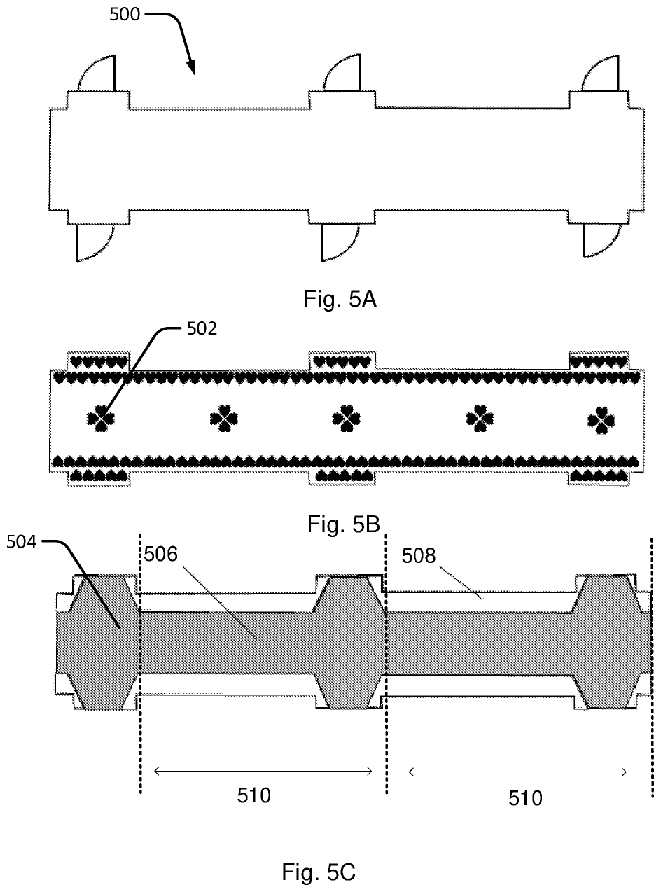

In some embodiments, the design may comprise a loading map, which indicates expected traffic on a carpet. The loading map may be used to vary the tufting density. For example, areas of expected high traffic are tufted with an increased density of tufts for extended carpet life. Similarly, areas of low expected traffic are tufted at a lower tuft density to reduce the amount of material required to produce a carpet. It may also be considered that materials are distributed across the carpet to optimise carpet longevity and material usage. This concept is illustrated in an example design shown in FIGS. 5A to 5C and discussed below.

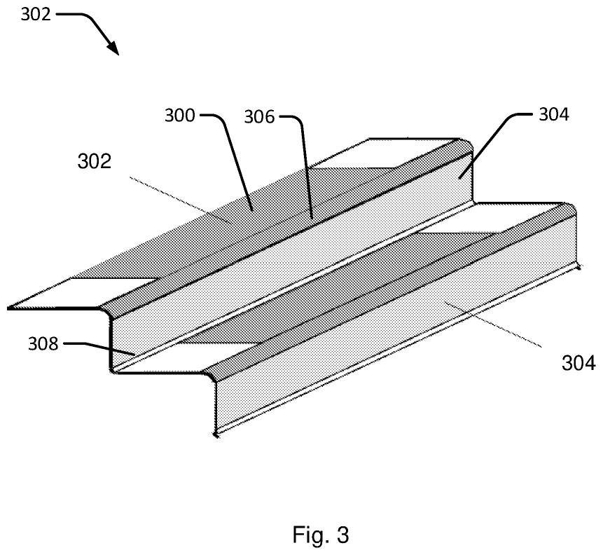

The design may further comprise a curvature of the carpet surface. The textile construction is then determined by the curvature. For example, consider a design for a carpet 300 to cover stairs 302 in FIG. 3. Stairs 302 comprise a stair tread 302, stair riser 304, stair nose 306 and stair corner 308.

At nose 306, the carpet 300 is curved, turning through an acute angle. Turning through this angle has the effect of opening 53 the pile 51 in the carpet as shown in FIG. 4E. Furthermore, the carpet at nose 306 is subject to maximum wear due to the curvature and location. The textile construction at nose 306 is adjusted such that pile height, indicated by arrow 402, would taper as it rounds the corner while at the same time the tufting density, indicated by decreased tufting spacing 404, would be increased to maximise wear resistance as shown in FIG. 4G. Another variation to the tufting construction may be to intersperse both high and low pile heights with the low pile height having a greater density so as to resist wearing through the carpet to the surface below.

At corner 308, carpet 300 turns though a ninety degree convex curvature causing the tips of the tufts to overlap and interfere with one another as illustrated in FIG. 4C. In this case, the textile construction can be varied to reduce the tufting density, as indicated by increased tufting spacing 406, and/or pile height, indicated by arrow 408, to prevent interfering as shown in FIG. 4F. Corner 308 is also a low wear location, meaning that there is no concern in reducing the tufting density in this location.

Similarly, the textile construction can be adjusted to reduce the tufting density on riser 304 which receives minimal wear.

In some embodiments, the design further comprises an acoustic map and the textile construction parameters are determined by the acoustic map. Carpet provides acoustic damping according to its textile structure. This embodiment provides a means of mapping the acoustic properties of carpet, over its area, to provide a measurable acoustic damping performance. Changes in textile structure within the carpet can be reflected in the acoustic properties in that area. Carpet can be used not only on the floor but on walls and ceilings to provide acoustic insulation.

Acoustic properties of a room or space may be measured or simulated by computer programs, to identifying localised noise levels. Acoustics vary by location within the space. Noise may be amplified in a space by reverberation, such as in corners of a room. Noise can be transmitted through a surface, such as engine vibration entering the interior of a motor vehicle. Installation of carpet over hard surfaces provides acoustic damping of a room or space.

This embodiment provides a means of designing carpet with acoustic properties varying textile structure according to location. The localised variation of textile structure parameters is achieved by varying tufting parameters such as, but not limited to, pile type, pile height, stitch spacing and stitch length and yarn type and density.

The benefit of the embodiment is optimising the acoustics of a carpeted space to enhance usability and comfort. It facilitates the use of carpet designed for acoustic improvement of walls and ceilings.

In some embodiments the design for a carpet may be too large for a robot tufter to produce as single item. In this case, the design is segmented based on the dimensions such that the dimensions of each segment allow for the robot tufter to produce it as a single item.

A custom carpet may be made according to a design which comprises a configuration of one or more motifs, also referred as an ornamentation. A boundary of a motif may not run parallel with the backing grid. When such a motif is tufted using a traditional robot tufter, the backing material may be distorted because the tufting gun generates tufts at fixed distances. So, when sequential tufts are not parallel to the grid geometry, the second tuft may not lie at a grid location.

However, method 100 described above is able to overcome this problem by defining the one or more specified grid locations as boundary locations of a motif. To do this, a motif boundary of a motif in a design for the custom carpet is identified.

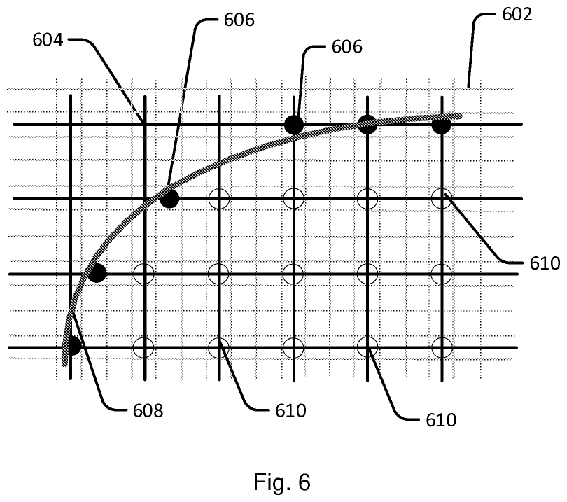

The identified motif boundary is then discretised to grid locations to determine the boundary locations. The tufting robot may then generate tufts at these boundary locations, which are located at grid locations, to tuft the boundary of the motif. An example of this is shown in FIG. 6

FIG. 6 shows the front side of the backing material grid 602 with the stitch grid 604 for needle penetrations superimposed. Stitch grid 604 is at an integral number of grid spacings (3 in this example). Each of the needle penetrations 606 becomes a tuft during the tufting process. The motif boundary is represented by vector shape outline 608 is shown superimposed on the backing grid. The needle penetrations 606 for motif boundary 608 on the front side of the backing material, that constitute the ends of outline stitch vectors, are located on lines of the stitch grid 604. Needle penetrations for fill stitch 610 conform to the spaces in the stitch grid.

In some instances, the motif boundary is discretised to grid locations that are separated by a minimum distance. This is done to maintain a more uniform tufting density.

To complete tufting of the motif, tufting is carried out within the boundary. The tufting within the boundary is performed by determining fill locations. The fill locations 610 are indexed locations within a motif and are found by discretising the fill of the motif to grid locations between, or within, the boundary locations. It will be appreciated that this may be done before the boundary is actually tufted.

To achieve a desired uniformity, the fill locations may be separated by an integral number of grid locations. In this case, the integral number of grid locations would be a stitch length or stitch spacing. In some embodiments, the integral number of grid locations is determined by the required tuft density specified in, or determined from, the design of the custom carpet.

An exemplary design is shown in FIGS. 5A to 5C. FIG. 5A illustrates a hallway 500 to be carpeted. The hallway provides shape and dimensions for the custom carpet. FIG. 5B illustrates the visual design of the carpet, including motifs 502. FIG. 5C illustrates a load map 504 overlaid on the carpet. High load areas 506, which are expected to experience greater traffic, will be tufted at a greater density to increase longevity of the carpet. Similarly, low load areas 508 adjacent the walls can be tufted at a lower density to conserve materials and manufacturing costs. Sections 510 are each tufted separately and they represent the largest dimensions that a robot tufter can produce.

### Data Files

Typically, instructions to control a robot tufter to tuft a given carpet design are stored in computer-aided manufacturing (CAM) file. To alter a design contained in a CAM file requires manual editing of the CAM data files to reflect the design changes. This may occur if the floorplan is incorrect and the carpet dimensions need to be modified. The editing process is laborious and time consuming.

The method described above allows for a simpler process to alter a design as the design can be edited as an image in one or more computer assisted design (CAD) files which can be automatically converted to a final CAM program. For example, the design may comprise a load map CAD file, a floor plan CAD file and a motif/ornamentation CAD file which are stored in a condensed vector format. Each of these may be different layers in a single CAD file or in different files which have a predetermined relationship between them. Typically, the relationship is defined by a transformation which maps the design maps to the floor plan. For example, the motif CAD file may scale with the floor plan, such that editing the floor plan will automatically edit the motif to fit the floor plan via the transformation. In general, all CAD files (defining the floor plan, motif/ornamentation, load map, acoustic map etc.) are related to each other via a transformation such that they can be enlarged, reduced or geometrically distorted in unison due to the relationship between the files.

Processor 802 can then receive the CAD files and grid geometry and automatically generate a CAM data file which specifies indexed grid locations for tufting. In some embodiments, the indexed grid locations comprise a list of vector movements for the tufting robot. Each movement by the robot is a stitch vector representing an individual tuft in a carpet. As an illustrative example, for a stitch spacing of 4 mm and row spacing of 8 mm, there could be up to 30,000 stiches or vectors per square metre—which can take a correspondingly large amount of memory storage for the whole carpet if that CAM data file was stored. Using the CAD files in condensed vector format assists in reducing storage requirements, whilst allowing the processor to generate the CAM data file when required that is consistent and repeatable.

That is, processor 802 is configured to automatically modify textile construction parameters stored in a CAM file based on modifications to the one or more CAD data files. As mentioned, the CAD data files are editable images which can be easily modified thereby simplifying design and manufacture of custom carpets. The benefit is eliminating unnecessary editing when creating variants of a visual design for carpets of differing dimensions.

An advantage of this is that the CAM files are directly scalable in relation to the vector shapes of the CAD files. Textile structures generated in the CAM software are linked to the CAD geometry. Tufting parameters are maintained to automatically create a new CAM data file reflecting the changes in geometry.

The methods described above therefore integrate and consolidate carpet design and manufacture in a single CAD file that captures all of the data, with minimum storage requirements, to produce a carpet. All aspects of the carpet design and manufacture may be viewed and reviewed in one program at one time. The methods enable carpet to be manufactured to meet the specifications of layout, visual design and textile construction to be produced. This enables a single designer to control and take responsibility of every aspect of carpeting.

### System

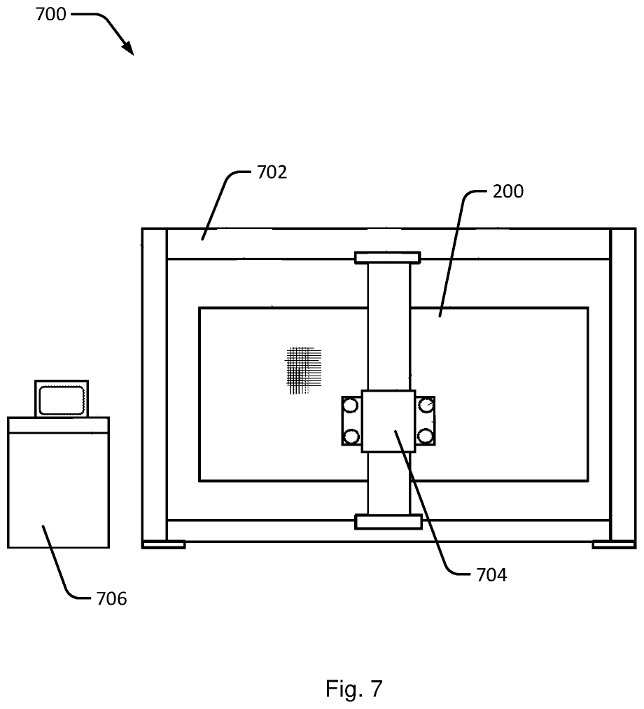

The methods described above can be implemented using a system 700, illustrated in FIG. 7. System 700 comprises a robot tufter and a controller 706 for controlling the robot tufter in accordance with the methods described above. The robot tufter comprises a tufting frame 702 for holding backing material 200 and a tufting head 704 having a tufting needle.

Controller 706 is shown in more detail in FIG. 8 and comprises a processor 802 connected to a program memory 804, a data memory 806, a communication port 808 and a user port 810 which functions as an interface device. The program memory 804 is a non-transitory computer readable medium, such as a hard drive, a solid state disk or CD-ROM. Software, that is, an executable program stored on program memory 804 causes the processor 802 to perform the method any one of the methods described above.

The processor 802 may receive data, such as grid geometry, from data memory 806 as well as from the communications port 808 and the user port 810. In one example, the processor 802 receives grid geometry from a backing material data repository 809 via communications port 808, such as by using a Wi-Fi network according to IEEE 802.11. The Wi-Fi network may be a decentralised ad-hoc network, such that no dedicated management infrastructure, such as a router, is required or a centralised network with a router or access point managing the network.

As mentioned, processor 802 performs the methods described above such as method 100 the instructions for which are stored in program data 804. The method stored in program data 804 is embodied in a software program written in a programming language such as C++ or Java. The resulting source code is then compiled and stored as computer executable instructions on program memory 804.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A computer implemented method for indexed tufting of a backing material by a robot tufter, the method comprising:
receiving or accessing grid geometry of a backing material wherein the grid geometry is based on a periodicity and dimensions of grid locations of the backing material and representative of optimal locations to receive a tufting needle;
determining indexed positions of grid locations of the backing material relative to the tufting needle of the robot tufter using a reference point that is fixed relative to the backing material; and
controlling the robot tufter to penetrate one or more specified indexed grid locations of the backing material with the tufting needle to create a tuft at the one or more specified indexed grid locations.

2. The method of claim 1 wherein the one or more specified indexed grid locations comprise boundary locations and wherein the boundary locations are determined by:
identifying a motif boundary of a motif in a design for a tufted article wherein the design comprises a configuration of one or more motifs of the tufted article, a shape of the article and dimensions of the article; and
discretising the motif boundary using the grid geometry to determine the boundary locations.

3. The method of claim 2 wherein the motif boundary is discretised to grid locations that are separated by a minimum distance.

4. The method of claim 2 or claim 3 wherein the one or more specified indexed locations further comprises fill locations, wherein the fill locations are discretised to grid locations between boundary locations.

5. The method of claim 4 wherein the fill locations are separated by an integral number of grid locations.

6. The method of claim 5 wherein the integral number of grid locations is determined by a tuft density specified in the design for the tufted article.

7. The method of claim 1 wherein controlling the robot tufter includes tufting the backing material in accordance with a design.

8. The method of any one claims 2 to 7 wherein the design comprises a textile construction parameters.

9. The method of claim 7 wherein the textile construction parameters comprise a tufting texture.

10. The method of claim 8 or claim 9 wherein the textile construction parameters comprise a tufting density.

11. The method of claim 10 wherein the design comprises a loading map and the tufting density is determined by the loading map.

12. The method of claim 9 wherein the design comprises a curvature of the article surface and the tufting density is determined by the curvature.

13. The method of any one claims 8 to 12 wherein the design comprises an acoustic map and the textile construction parameters are determined by the acoustic map.

14. The method of any one of the preceding claims wherein determining the indexed position of grid locations comprises segmenting the design based on the dimensions.

15. The method of any one of the preceding claims wherein the design is specified by a computer assisted design (CAD) file and the step of determining indexed positions of grid locations comprises generating a computer aided manufacturing (CAM) file based on the CAD file and the grid geometry of the backing material.

16. The method of claim 15 wherein the CAM file comprises a list of vector movements to control the robot tufter.

17. A system for indexed tufting of a backing material, the system comprising:
a robot tufter comprising:
a tufting frame for holding a backing material to be tufted;
a tufting head having a tufting needle to create one or more tufts in the backing material; and
a controller to control the robot tufter, the controller configured to:
receive or access grid geometry of the backing material wherein the grid geometry is based on a periodicity and dimensions of grid locations of the backing material and representative of optimal locations to receive the tufting needle;
determine indexed positions of grid locations of the backing material relative to the tufting needle of the robot tufter using a reference point that is fixed relative to the backing material; and
control the robot tufter to penetrate one or more specified indexed grid locations of the backing material with the tufting needle to create a tuft at the one or more specified indexed grid locations.

18. A tufted article produced using the method of any one of claims 1 to 16.

19. A non-transitory computer readable medium configured to store software instructions that when executed cause a processor to perform the method of any one of claims 1 to 16.

20. A non-transitory computer readable medium configured to store software instructions that when executed cause a processor to:
receive or access grid geometry of the backing material wherein the grid geometry is based on a periodicity and dimensions of grid locations of the backing material and representative of optimal locations to receive the tufting needle;
determine indexed positions of grid locations of the backing material relative to the tufting needle of the robot tufter using a reference point that is fixed relative to the backing material; and
control the robot tufter to penetrate one or more specified indexed grid locations of the backing material with the tufting needle to create a tuft at the one or more specified indexed grid locations.

21. A computer implemented method of producing the CAD file of claim 15, the method comprising:
receiving a floor plan in a condensed vector format;
receiving textile construction parameters;
generating a first transformation, for the textile construction parameters, using the floor plan; and
generating a design by applying the first transformation to the textile construction parameters.

22. A computer-implemented method according to claim 21 further comprising:
receiving an ornamentation pattern;
generating a second transformation, for the ornamentation pattern, using the floor plan; and
wherein generating the design by applying the first transformation to the textile construction parameters further comprises applying the second transformation to the ornamentation pattern.
